(19) United States
(12) Patent Application Publication
(10) Pub. No.: US 2026/0008256 A1
(43) Pub. Date: Jan. 8, 2026

(54) HIGH-TOUGHNESS, RECYCLABLE PACKAGING FILM WITH MULTIFUNCTIONAL COMPATIBILIZER

(71) Applicant: PROAMPAC HOLDINGS INC., Cincinnati, OH (US)

(72) Inventors: Ebrahim Jalali Dil, Montreal (CA); Amir Saffar, Laval (CA); Joseph J. Buchanan, Appleton, WI (US)

(21) Appl. No.: 19/259,149

(22) Filed: Jul. 3, 2025

Related U.S. Application Data
(60) Provisional application No. 63/668,621, filed on Jul. 8, 2024.

(51) Int. Cl. B32B 27/08; B32B 7/12; B32B 27/18; B32B 27/30; B32B 27/32; B32B 27/34; B32B 27/36

(52) U.S. Cl. CPC B32B 27/08; B32B 7/12; B32B 27/18; B32B 27/306; B32B 27/32; B32B 27/34; B32B 27/36; B32B 2250/02; B32B 2250/03; B32B 2250/04; B32B 2250/05; B32B 2270/00; B32B 2307/4023; B32B 2553/00

(57) ABSTRACT

A laminated recyclable polyolefin-based film structure comprises an oriented film outer layer comprising a polar polymer. At least one polymer-based film layer comprises a polyolefin polymer and a multifunctional polar polymer compatibilizer, wherein the multifunctional polar polymer compatibilizer comprises a polyolefin functionalized with at least two different functional groups. Packaging articles formed of the film structure are also provided. The oriented film outer layer imparts good mechanical and/or heat resistance properties to the film.

### CROSS REFERENCE TO RELATED APPLICATION

This application claims the priority benefit of U.S. Provisional Patent Application No. 63/668,621 filed Jul. 8, 2024. The aforementioned application is incorporated herein by reference in its entirety.

### BACKGROUND

The present invention relates to flexible packaging films and, in particular, to recyclable, laminated film structures comprising a polar polymer layer and one or more polymer-based film layers comprising a multifunctional compatibilizer.

Nonpolar polymers such as polyolefins and polar polymers such as nylon, ethylene vinyl alcohol copolymers (EVOH) and polyesters are generally not compatible in recycling processes due to immiscibility. This incompatibility leads to phase separation when melted during the recycling process where the polar polymers form discrete domains within the nonpolar matrix. These polar domains can aggregate, creating weak points in the recycled material, reducing mechanical properties, and leading to defects in the final product.

Adding a compatibilizer promotes the formation of smaller and more dispersed polar domains within the nonpolar matrix and mitigates the risk of macroscopic phase separation. Compatibilizers react or interact with polar groups such as amide groups in polyamides (such as nylon), hydroxyl groups in ethylene vinyl alcohol (EVOH) and ester groups in polyesters (such as polyethylene terephthalate (PET)) to avoid agglomeration of polar polymers during recycling process.

Various advantages and benefits of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is a side cross sectional view of a first embodiment laminated film structure in accordance with the present disclosure.

FIG. 2 is a side cross sectional view of a second embodiment laminated film structure in accordance with the present disclosure.

FIG. 3 is a side cross sectional view of a third embodiment laminated film structure in accordance with the present disclosure.

FIG. 4 is a side cross sectional view of a first exemplary polymer-based film layer of the film structures appearing in FIGS. 1-3.

FIG. 5 is a side cross sectional view of a second exemplary polymer-based film layer of the film structures appearing in FIGS. 1-3.

FIG. 6 is a side cross sectional view of a third exemplary polymer-based film layer of the film structures appearing in FIGS. 1-3.

FIG. 7 is a side cross sectional view of a fourth exemplary polymer-based film layer of the film structures appearing in FIGS. 1-3.

FIG. 8 is a side cross sectional view of a first exemplary barrier layer of the film structures appearing in FIGS. 5-7.

FIG. 9 is a side cross sectional view of a second exemplary barrier layer of the film structures appearing in FIGS. 5-7.

FIG. 10 is a side cross sectional view of a first exemplary outer layer of the film structures appearing in FIGS. 1-3.

FIG. 11 is a side cross sectional view of a second exemplary outer layer of the film structures appearing in FIGS. 1-3.

FIG. 12 is a side cross sectional view of a third exemplary outer layer of the film structures appearing in FIGS. 1-3.

FIG. 13 is a side cross sectional view of a fourth exemplary outer layer of the film structures appearing in FIGS. 1-3.

FIG. 14 is a side cross sectional view of a fifth exemplary outer layer of the film structures appearing in FIGS. 1-3.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The term “directly contacts,” “in direct contact with,” “directly adhered to,” or similar terms as used herein, refers to a layer configuration whereby a first layer is located immediately adjacent to a second layer, the first layer touches the second layer, and no intervening layers, and/or no intervening structures, are present between the first layer and the second layer. The terms “indirectly contacts” or “in indirect contact with,” or similar terms as used herein, refers to a layer configuration whereby an intervening layer, or an intervening structure, is present between the first layer and the second layer.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5). Accordingly, unless indicated to the contrary, the numerical parameters set forth in the present specification and attached claims are approximations that can vary depending upon the desired properties sought to be obtained by the presently disclosed subject matter.

As used herein, the term “about,” when referring to a value can encompass variations of, in some embodiments ±20%, in some embodiments ±10%, in some embodiments ±5%, in some embodiments ±1%, in some embodiments ±0.5%, in some embodiments ±0.1%, and in some embodiments to ±0.01%, from the specified amount, as such variations are appropriate in the disclosed materials and methods.

The terms “outer” and “inner” are used herein to refer to a position in relation to a product to be packaged using the multilayer packaging structures herein, while the terms “exterior” and “interior” are used herein to refer to a position in relation to other layers of the multilayer packaging structures herein.

As used herein, the term “outer” in connection with a layer or a ply refers to a layer or ply of a multilayer packaging structure which is furthest from the product to be packaged in relation to the other layers of the multilayer structure. The term “outward facing surface” of a layer of a multilayer packaging structure is the surface of such layer that faces away from the product being packaged within a multilayer packaging structure herein or a packaging article formed thereof. The term “outer surface” of a multilayer packaging structure is the surface of the structure that is intended to face away from a product being packaged within the structure.

As used herein, the term “inner” in connection with a layer or a ply refers to a layer or ply of a multilayer packaging structure which is closest to or is intended to contact the product to be packaged within a multilayer structure herein in relation to the other layers of the multilayer structure. The term “inward facing surface” of a layer or ply of a multilayer packaging structure herein is the surface of such layer that is intended to face toward the product being packaged within a multilayer packaging structure herein or a packaging article formed thereof. The term “inner surface” of a multilayer packaging structure herein is the surface of the structure that faces toward or is intended to face toward or contact a product being packaged within the structure.

As used herein, the term “interior” in connection with a layer or a ply refers to a layer or ply within a multilayer packaging structure herein is that is not exposed to handling and the environment. Interior layers may provide functionality as needed for particular applications. For example, interior layers may provide barrier protection and/or structural strength. As an example, an exemplary interior layer provides protection to packaged food or other product for freshness and/or a barrier to moisture and/or oxygen, and/or a barrier to migration of moisture, oils, and the like from packaged food or other product from the inner surface of the multilayer packaging structure to the outer surface of the multilayer packaging structure. As another example, an interior layer may also be a structural layer which provides one or more properties including but not limited to general durability, puncture strength, resistance to deformation, tear or flex crack resistance, and the like.

As used herein, the term “exterior” in connection with a layer or a ply refers to a layer or ply which comes in immediate contact with the outside environment or atmosphere. Therefore, the multilayer packaging structures herein have two exterior layers, namely, the inner layer and the outer layer.

As used herein, the term “extrusion” is used with reference to the process of forming shapes such as a melt curtain by forcing a molten plastic material through a die, followed by cooling or chemical hardening. Immediately prior to extrusion through the die, the polymeric material is fed into a rotating screw, i.e., an extruder that forces the polymeric material through the die. The term “continuous extrusion” refers to an extrusion process wherein the die is designed to produce a continuous flow or curtain of molten polymer without breaks or gaps. The term “discontinuous extrusion” refers to an extrusion process wherein the die is designed to produce a patterned or otherwise discontinuous flow or curtain of molten polymer. For example, the die may have multiple orifices that allow the polymer to be extruded in a pattern or with gaps in between extruded portions.

As used herein, the term “extrusion coating” is used in reference to a process wherein a molten polymer is extruded through a die and applied as a coating onto a substrate to form a coated substrate.

As used herein, the term “extrusion lamination” is used in reference to a process where a molten polymer is extruded through a die and then immediately laminated onto a first substrate and passes through a nip between the extrusion die and a second substrate, wherein the molten polymer forms an extrusion interlayer and bonds the two substrates together to form a laminated structure.

As used herein, the term “coextrusion” refers to the process of extruding two or more materials through a single die with two or more orifices arranged so that the extrudates merge and weld together into a laminar structure before chilling, i.e., quenching.

As used herein, the terms “packaging structure,” “packaging film structure,” and the like refer to a web of sheet material having a structure as disclosed herein, as well as a packaging article manufactured therefrom, including sheets or wraps, bags, pouches, and the like.

As used herein, the term “polar polymer” refers to a polymer that contains electronegative groups or polar functional groups such as hydroxyl groups, carbonyl groups, carboxyl groups, carboxylate groups, ester groups, amide groups, ether groups, nitrile groups, or similar groups. These groups impart polarity to the polymer, such as an ability to form hydrogen bonds or polar/polar interactions, resulting in an increased affinity for polar substances. Examples of polar polymers include, but are not limited to, polyamides, ethylene vinyl alcohol copolymer (EVOH), polyesters, acrylates, and copolymers or blends thereof.

As used herein, the term “compatibilizer” refers to a composition configured to enhance the miscibility or compatibility of polar and nonpolar polymers and reduce the aggregation of polar polymer phase domains within a nonpolar polymer matrix. This improved compatibility facilitates the formation of more homogeneous blends during melting and extrusion stages of the recycling process, enabling the efficient reprocessing of polymer materials containing both nonpolar and polar polymer components.

As used herein, unless specifically stated otherwise, the terms “multifunctional compatibilizer” and “multifunctionalized compatibilizer” are used interchangeably, without regard to possible nuances in connotation, and encompass compatibilizers that have been functionalized through post-polymerization modification as well as compatibilizers wherein the polymer structure has been functionalized directly by employing two or more functional monomers, optionally in combination with other monomers, through copolymerization or other suitable polymerization technique. In addition, the terms “multifunctional compatibilizer” and “multifunctionalized compatibilizer” also encompass compatibilizers that include functional groups introduced through a combination of approaches, such as one or more functional groups incorporated directly before or during polymerization via one or more functional monomers and one or more functional groups introduced via post-polymerization modification. Accordingly, a compatibilizer may be considered “multifunctional” or “multifunctionalized” irrespective of whether the functional groups are introduced pre-, during, or post-polymerization, or any combination thereof.

As used herein, unless specifically stated otherwise, the term “copolymer” refers to a polymer that is derived from two or more different monomer species, including without limitation binary copolymers, terpolymers, tetrapolymers, pentapolymers, and higher-order copolymers.

As used herein, the term “oriented” refers to polymer films that have been subjected to a stretching process either during film extrusion or post-extrusion to align the polymer chains in one or more directions. The term includes both monoaxially oriented films, where the polymer chains are aligned predominantly in one direction, and biaxially oriented films, where the polymer chains are aligned in two perpendicular directions. Oriented films are typically characterized by one or more improved mechanical properties, such as strength, clarity, tensile strength, heat resistance, abrasion resistance, puncture resistance, barrier properties, dimensional stability, and improved performance in Gelbo Flex testing, as compared to non-oriented films.

All compositional percentages used herein are presented on a “by weight” basis, unless specifically stated otherwise.

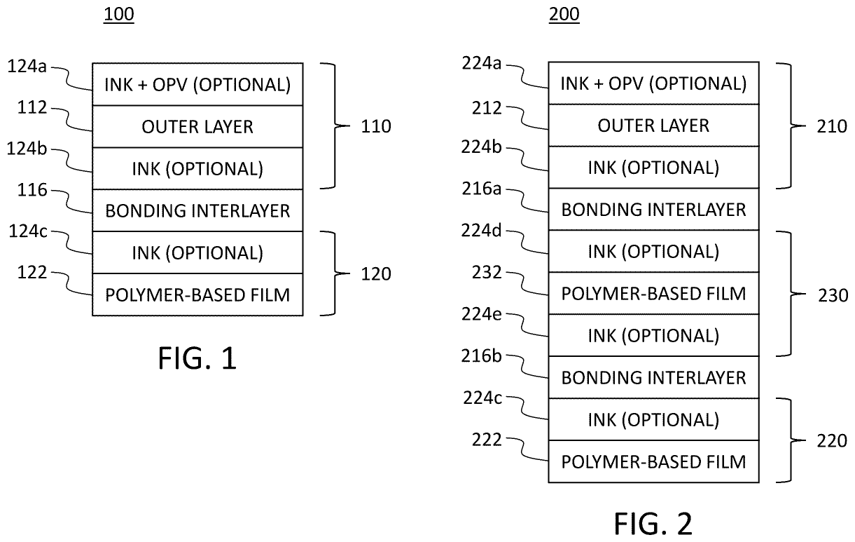

Referring now to the drawings, like reference numerals are used to describe like or analogous items in which the hundreds digit has been increased to correspond to the figure number (e.g., outer ply 110 in FIG. 1 corresponds to outer ply 210 in FIG. 2, and so forth). The description in reference to any given reference numeral herein is equally applicable to other reference numerals that differ only in the hundreds digit, unless specifically stated otherwise.

Referring now to FIGS. 1-3, there are shown exemplary packaging structures produced in accordance with exemplary embodiments of the present invention. With reference to FIG. 1, a first embodiment packaging film structure 100 includes an outer film ply 110 which is laminated to an inner film ply 120 via a bonding interlayer 116 which is disposed intermediate the outer and inner plies 110 and 120, respectively. The outer film ply 110 is an outer film ply and the inner film ply 120 is an inner film ply. Both the outer film ply 110 and the inner film ply 120 are exterior film plies.

The bonding interlayer 116 is interposed between the outer film ply 110 and the inner film ply 120 to form a laminated structure. In certain embodiments, the bonding interlayer 116 is an adhesive layer. In certain embodiments, the bonding interlayer 116 is an extruded polymer interlayer.

In embodiments wherein the bonding interlayer 116 is an adhesive, the adhesive may be any suitable adhesive, including single component adhesives, two component adhesives, solvent-based adhesives, solventless adhesives, water-based adhesives, acrylic adhesives, polyurethane adhesives, electron beam lamination adhesives, and UV lamination adhesives, as would be understood by persons skilled in the art.

In embodiments wherein the bonding interlayer 116 is an extruded polymer interlayer, the polymer may be any suitable polymer used for extrusion lamination, including low-density polyethylene (LDPE), linear low-density polyethylene (LLDPE), high-density polyethylene (HDPE), polypropylene (PP), ethylene-vinyl acetate (EVA), ethylene-methyl acrylate (EMA), ethylene-acrylic acid (EAA), ethylene-methacrylic acid (EMAA), ethylene-methyl methacrylate (EMMA), ionomers, and blends thereof, as would be understood by persons skilled in the art.

The outer ply 110 comprises an outer layer 112 comprising a polar polymer. In certain embodiments, the outer ply 110 comprises an outer layer 112 comprising an oriented film layer formed of a polar polymer. In certain embodiments, the outer ply 110 comprises an outer layer 112 comprising a blown or cast polar polymer film, with or without any additional stretching or orientation of the film after the initial blown or cast film extrusion process. The outer layer 112 may be a monolayer or multilayer structure. In embodiments, the outer layer 112 is formed of at least one polar polymer selected from polyamides, polyesters, olefin-vinyl alcohol copolymers, or a combination thereof.

The one or more polar polymers used to form the outer layer 112 may comprise virgin polymer material. Alternatively, the one or more polar polymers used to form the outer layer 112 may comprise post-consumer recycled (PCR) polymer material. In still further embodiments, the one or more polar polymers used to form the outer layer 112 may comprise a blend of virgin polymer material and PCR polymer material. As used herein, “post-consumer recycled material” refers to polymeric material recovered from consumer use, e.g., which has been collected, sorted, cleaned, and reprocessed for reuse.

In embodiments, it will be understood that the PCR content may be present in the outer layer 112 in an amount from 0% to 100% by weight of the outer layer 112, including blends of PCR with virgin polymer. It will be understood that the PCR polymer material may comprise one or more impurities, including without limitation, additional polymeric materials that are distinct from the predominant polymer component. In certain embodiments, such impurities may include polymeric materials that are chemically or physically incompatible with the predominant polymer component. For example, where the predominant component of the PCR polymer material is a polar polymer, such as a polyamide (e.g., nylon), ethylene vinyl alcohol (EVOH), or polyester, the material may additionally comprise minor amounts of non-polar polymers, or other polar polymers that are incompatible therewith. Conversely, where the predominant component of the PCR polymer material is a non-polar polymer (e.g., polyethylene, polypropylene, or mixed polyolefin), the material may contain impurities comprising polar polymers, such as polyamide, EVOH, or polyester.

For example, when the outer layer 112 is formed of a polyamide, it will be recognized that the polyamide may encompass virgin polyamide alone, PCR polyamide alone, or a blend of virgin polyamide and PCR polyamide. Likewise, when the outer layer 112 is formed of a polyester, it will be recognized that the polyester may encompass virgin polyester alone, PCR polyester alone, or a blend of virgin polyester and PCR polyester. Similarly, when the outer layer 112 is formed of an olefin-vinyl alcohol copolymer, it will be recognized that the olefin-vinyl alcohol copolymer may encompass olefin-vinyl alcohol copolymer alone, PCR olefin-vinyl alcohol copolymer alone, or a blend of virgin olefin-vinyl alcohol copolymer and PCR olefin-vinyl alcohol copolymer.

In addition, any of the polar polymers used for the outer layer 112 may be blended with PCR polymer material derived from a different polymer type. Such blended polymer materials are considered within the scope of the polymers described herein.

In certain embodiments, the polar polymer utilized for the outer layer 112 comprises a polyamide. Exemplary polyamides include, but are not limited to, nylons such as nylon 6, nylon 66, nylon 6/66, nylon 12, and blends and copolymers thereof. In embodiments, the outer layer 112 is biaxially oriented nylon (BON). In embodiments, the outer layer 112 is monoaxially oriented nylon.

In embodiments, the outer layer 112 is formed of polyamide which has been formed into a film by a cast film process. In embodiments, the outer layer 112 is formed of cast nylon film. In embodiments, the outer layer 112 is formed of polyamide which has been formed into a film by a cast film process and oriented either during film casting or post casting. In embodiments, the outer layer 112 is formed of oriented cast nylon, e.g., oriented cast nylon 6, oriented cast nylon 66, oriented cast nylon 6/66, oriented cast nylon 12, and blends and copolymers thereof. In embodiments, the outer layer 112 is formed of polyamide which has been formed into a film by a cast film process without any stretching either during film casting or post casting. In embodiments, the outer layer 112 is formed of non-oriented cast nylon film, e.g., non-oriented cast nylon 6, non-oriented cast nylon 66, non-oriented cast nylon 6/66, non-oriented cast nylon 12, and blends and copolymers thereof.

In embodiments, the outer layer 112 is formed of polyamide which has been formed into a film by a blown film process, including single bubble, double bubble, and triple bubble formation processes. In embodiments, the outer layer 112 is formed of blown polyamide film. In embodiments, the outer layer 112 is formed of blown nylon film, e.g., blown nylon 6, blown nylon 66, blown nylon 6/66, blown cast nylon 12, and blends and copolymers thereof. In embodiments, the outer layer 112 is formed of polyamide which has been formed into a film by a blown film process and further oriented or stretched after the blown film extrusion process. In embodiments, the outer layer 112 is formed of polyamide which has been formed into a film by a blown film process without any further stretching after the blown film extrusion process.

In certain embodiments, the polar polymer utilized for the outer layer 112 comprises a polyester. Exemplary polyesters include, but are not limited to, polyethylene terephthalate (PET), polybutylene terephthalate (PBT), and copolymers or blends thereof. In embodiments, the outer layer 112 is oriented PET (OPET) or biaxially oriented PET (BOPET).

The inner film ply 120 includes a polymer-based film layer 122, which may be a monolayer or multilayer structure and optionally includes a moisture vapor barrier layer, an oxygen barrier layer, or both. In preferred embodiments, the innermost surface of the polymer-based film layer 122 comprises a heat-scalable polymer configured to form a hermetic seal with itself or similar surfaces under predetermined sealing conditions, i.e., sealing temperature, scaling pressure, and dwell time.

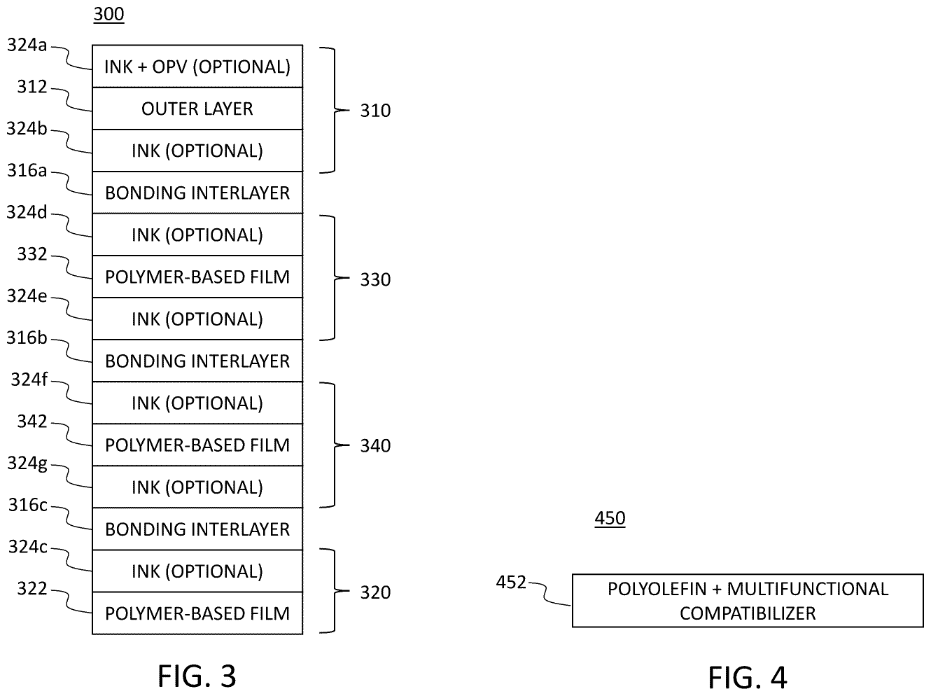

In embodiments, the polymer-based film layer 122 comprises a nonpolar polymer admixed with a multifunctional polyolefin-based compatibilizer. The amount of multifunctional compatibilizer to be added to the nonpolar polymer will vary directly with the concentration or quantity of polar groups present in the overall structure 100. It will be recognized that polar groups are present not only in the outer layer 112 as described above, but may also be present, e.g., in any optional barrier layer in the inner ply 120 of FIG. 1 and/or within an in an intermediate ply 230, 330, and 340, as shown in FIGS. 2 and 3. For example, as described below, the polymer-based film layer 122 may include one or more polar polymer barrier layers, such as EVOH, polyamide, and polyvinyl alcohol (PVOH). The compatibilizer should be present in an amount sufficient to compatibilize not only the polar polymer present in the outer layer 112, but also any additional polar polymer as may present elsewhere, e.g., as a barrier layer, in the overall structure 100.

In certain embodiments, as described below, the nonpolar component(s) of the polymer-based film layer 122 comprise a PCR polyolefin material, including without limitation PCR polyethylene, PCR polypropylene, and PCR mixed polyolefins. As discussed above, it will be understood that such PCR polyolefin materials may contain impurities, such as polar polymer materials including polyamide, EVOH, polyester, and other materials. Accordingly, the inclusion of PCR polyolefin may contribute to the total mount of polar polymer in the structure 100 and, thus, the amount of multifunctional compatibilizer employed may be adjusted to account for the potential presence of polar polymer in the PCR polyolefin. Such adjustments are considered to be within the scope of the present disclosure.

In embodiments, the multifunctional compatibilizer is present in an amount ranging from about 0.5% to about 10% by weight based on the weight of the structure 100, e.g., about 0.5% 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, and 10%, or within any subrange thereof. In preferred embodiments, the multifunctional compatibilizer is present in an amount ranging from about 1% to about 4% by weight based on the weight of the structure 100.

The polymer-based film layer 122 comprises a monolayer or multilayer structure. In embodiments, the nonpolar polymer component(s) of the polymer-based film layer 122 is a polyolefin-based polymer. Examples of polyolefin-based polymers include polyethylene (PE), polypropylene (PP), polyolefin blends, or polyolefin copolymers. In embodiments, the nonpolar polymer component(s) of the polymer-based film layer 122 comprises low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymers (COC), cast polypropylene (CPP), ethylene-propylene copolymer (EPC), monoaxially- and biaxially-oriented polyolefins including without limitation biaxially oriented polypropylene (BOPP), and other polyolefin materials, including post-consumer recycled (PCR) polyolefins, as well as blends, coextrusions, and laminations of any of the foregoing, provided that at least the exterior most layer is a heat sealable polyolefin layer. In embodiments, the nonpolar polymer component(s) of the polymer-based film layer 122 may be a copolymer of polyethylene and polypropylene, such as an ethylene-propylene copolymer. In embodiments, the nonpolar polymer component(s) of the polymer-based film layer 122 may be a coextruded film with a barrier layer and optional tie resin layers as would be understood by persons skilled in the art. In embodiments, the barrier layer is selected from ethylene vinyl alcohol copolymer (EVOH), polyamide (PA), such as nylon 6, nylon 66, nylon 6/66, PVOH, and the like.

In certain embodiments, an optional ink layer 124a is disposed on the outward facing surface of the outer layer 112. The ink layer 124a provides printed indicia intended to appear on a packaging structure formed from the film structure 100. Because the printing ink layer 124a is applied to the outward facing surface of the outer layer 112, the printed material is effected in a forward printed format. The printing ink layer 124a can be applied to the outer surface of the outer layer 112 via any conventional printing method as would be understood by persons skilled in the art, including without limitation, using a rotogravure printing apparatus, flexographic printing apparatus, offset printing apparatus, digital printing apparatus, ink jet printing apparatus, and the like. In embodiments where the ink layer 124a is present, it may also include an overprint varnish to protect the ink and enhance durability against scuffing, abrasion, environmental factors, and otherwise maintain the integrity of the printed indicia.

In certain embodiments, an optional ink layer 124b is disposed on the inward facing surface of the outer layer 112. The ink layer 124b provides printed indicia intended to appear on a packaging structure formed from the film structure 100. Because the printing ink layer 124b is applied to the inward facing surface of the outer layer 112, the printed material is effected in a reverse (mirror image) printed format. The printing ink layer 124b can be applied to the inner surface of the outer layer 112 via any conventional printing method as would be understood by persons skilled in the art, including without limitation, using a rotogravure printing apparatus, flexographic printing apparatus, offset printing apparatus, digital printing apparatus, ink jet printing apparatus, and the like.

In certain embodiments, an optional ink layer 124c is disposed on the outward facing surface of the polymer-based film layer 122. The ink layer 124c provides printed indicia intended to appear on a packaging structure formed from the film structure 100. Because the printing ink layer 124c is applied to the outward facing surface of the polymer-based film layer 122, the printed material is effected in a forward printed format. The printing ink layer 124c can be applied to the outer surface of the polymer-based film layer 122 via any conventional printing method as would be understood by persons skilled in the art, including without limitation, using a rotogravure printing apparatus, flexographic printing apparatus, offset printing apparatus, digital printing apparatus, ink jet printing apparatus, and the like.

While FIG. 1 illustrates potential configurations with ink layers 124a depicted on the outer surface of the outer layer 112, 124b depicted on the inner surface of the outer layer 112, and 124c depicted on the outward facing surface of the polymer-based film layer 122 for case of illustration, it will be understood that in practical embodiments of the film structure 100, a printed ink layer will typically be applied at only one of these locations. The selection of the location of the ink layer may depend on factors such as desired aesthetics, functional requirements, or manufacturing considerations.

The structure 100 can be formed using conventional lamination techniques, such as adhesive lamination or extrusion lamination techniques. When the bonding interlayer 116 is an adhesive, an adhesive layer is applied between the plies 110 and 120 and the plies 110 and 120 are bonded under suitable conditions. The adhesive may be applied to the surface of at least one of the plies 110 and 120, via any suitable coating method, e.g., spray coating, roll coating, blade coating, or similar technique. When the bonding interlayer 116 is an extrusion interlayer, the bonding interlayer is extruded and brought onto a surface of one of the plies 110 and 120 as a melt curtain, e.g., just before the nip of lamination rollers, to laminate the plies 110 and 120.

With reference now to FIG. 2, a second embodiment packaging film structure 200 includes an outer film ply 210 which is laminated to an intermediate film ply 230 via a first bonding interlayer 216a which is disposed intermediate the outer and intermediate plies 210 and 230, respectively. The outer film ply 210 is an exterior film ply and the intermediate film ply 230 is an interior film ply.

The intermediate film ply 230 is, in turn, laminated to an inner film ply 220 via a second bonding interlayer 216b which is disposed intermediate the intermediate and inner plies 230 and 220, respectively. The inner film ply 220 is an exterior film ply.

The first bonding interlayer 216a is interposed between the outer film ply 210 and the intermediate film ply 230, and the second bonding interlayer 216b is interposed between the intermediate film ply 230 and the inner film ply 220 to form a laminated structure. In certain embodiments, the bonding interlayers 216a and 216b, which can be the same or different, are independently selected from an adhesive layer and an extruded polymer interlayer, which can be as described above by way of reference to the bonding interlayer 116 appearing in FIG. 1.

The outer ply 210 comprises an outer layer 212, which may be as described above by way of reference to the outer layer 112 appearing in FIG. 1.

The inner film ply 220 including the polymer-based film layer 222, wherein the inner film ply 220 and the polymer-based film layer 222 may be as described above by way of reference to the inner film ply 120 and polymer-based film layer 122 appearing in FIG. 1.

The intermediate ply 230 includes an intermediate polymer based film layer 232, which may be a monolayer or multilayer structure and optionally includes a moisture vapor barrier layer, an oxygen barrier layer, or both.

In embodiments, the polymer-based film layer 222 comprises a nonpolar polymer admixed with a multifunctional polyolefin-based compatibilizer. The amount of multifunctional compatibilizer to be added to the nonpolar polymer depends on the concentration of polar groups present in the overall structure 200. It will be recognized that polar groups are present not only in the outer layer 212 as described above, but also, also in any optional barrier layer in the inner ply 220 and any optional barrier layer in the intermediate ply 230. As described below, the polymer-based film 232 may include one or more polar polymer barrier layers, such as EVOH, polyamide, and PVOH. In embodiments, the multifunctional compatibilizer is present in an amount ranging from about 0.5% to about 10% by weight based on the weight of the structure 200, e.g., about 0.5% 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, and 10%, or within any subrange thereof. In preferred embodiments, the multifunctional compatibilizer is present in an amount ranging from about 1% to about 4% by weight based on the weight of the structure 200.

The polymer-based film layer 232 comprises a monolayer or multilayer structure. In embodiments, the nonpolar polymer component(s) of the polymer-based film layer 232 is a polyolefin-based polymer. Examples of polyolefin-based polymers include polyethylene (PE), polypropylene (PP), polyolefin blends, or polyolefin copolymers. In embodiments, the nonpolar polymer component(s) of the polymer-based film layer 232 comprises low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymers (COC), cast polypropylene (CPP), ethylene-propylene copolymer (EPC), monoaxially- and biaxially-oriented polyolefins including without limitation biaxially oriented polypropylene (BOPP), and other polyolefin materials, including post-consumer recycled (PCR) polyolefins, as well as blends, coextrusions, and laminations of any of the foregoing, provided that at least the exterior most layer is a heat sealable polyolefin layer. In embodiments, the nonpolar polymer component(s) of the polymer-based film layer 232 may be a copolymer of polyethylene and polypropylene, such as an ethylene-propylene copolymer or cyclic olefin copolymers (COC). In embodiments, the nonpolar polymer component(s) of the polymer-based film layer 232 may be a coextruded film with a barrier layer and optional tie resin layers as would be understood by persons skilled in the art. In embodiments, the barrier layer is selected from ethylene vinyl alcohol (EVOH), polyamide (PA), such as nylon 6, nylon 66, nylon 6/66, PVOH, and the like.

In certain embodiments, an optional ink layer 224a is disposed on the outward facing surface of the outer layer 212. The ink layer 224a may be as described above by way of reference to the ink layer 124a appearing in FIG. 1.

In certain embodiments, an optional ink layer 224b is disposed on the inward facing surface of the outer layer 212. The ink layer 224b may be as described above by way of reference to the ink layer 124b appearing in FIG. 1.

In certain embodiments, an optional ink layer 224c is disposed on the outward facing surface of the polymer-based film layer 222. The ink layer 224c may be as described above by way of reference to the ink layer 124c appearing in FIG. 1.

In certain embodiments, an optional ink layer 224d is disposed on the outward facing surface of the polymer-based film layer 232. The ink layer 224d provides printed indicia intended to appear on a packaging structure formed from the film structure 200. Because the printing ink layer 224d is applied to the outward facing surface of the polymer-based film layer 232, the printed material is effected in a forward printed format. The printing ink layer 224d can be applied to the outer surface of the polymer-based film layer 232 via any conventional printing method as would be understood by persons skilled in the art, including without limitation, using a rotogravure printing apparatus, flexographic printing apparatus, offset printing apparatus, digital printing apparatus, ink jet printing apparatus, and the like.

In certain embodiments, an optional ink layer 224e is disposed on the inward facing surface of the polymer-based film layer 232. The ink layer 224e provides printed indicia intended to appear on a packaging structure formed from the film structure 200. Because the printing ink layer 224e is applied to the inward facing surface of the polymer-based film layer 232, the printed material is effected in a reverse (mirror image) printed format. The printing ink layer 224e can be applied to the inner surface of the polymer-based film layer 232 via any conventional printing method as would be understood by persons skilled in the art, including without limitation, using a rotogravure printing apparatus, flexographic printing apparatus, offset printing apparatus, digital printing apparatus, ink jet printing apparatus, and the like.

While FIG. 2 illustrates potential configurations with ink layers 224a depicted on the outer surface of the outer layer 212, 224b depicted on the inner surface of the outer layer 212, 224c depicted on the outward facing surface of the polymer-based film layer 222, 224d depicted on the outer surface of the intermediate layer 232, and 224e depicted on the inner surface of the intermediate layer 232 for case of illustration, it should be understood that in practical embodiments of the film structure 200, a printed ink layer will typically be applied at only one of these locations. The selection of the location of the ink layer may depend on factors such as desired aesthetics, functional requirements, or manufacturing considerations.

The structure 200 can be formed using conventional lamination techniques, such as adhesive lamination or extrusion lamination techniques. When the bonding interlayers 216a or 216b, which are independent of each other and can be the same or different, are adhesive layers, the adhesive is applied between the respective pair of adjacent plies 210 and 230 or plies 230 and 220 and bonded under suitable conditions. The adhesive may be applied to either or both facing surfaces to be bonded via any suitable coating method, such as spray coating, roll coating, blade coating, or similar techniques. When the bonding interlayers 216a or 216b are extrusion interlayers, the bonding interlayer is extruded onto a surface of the respective pair of adjacent plies 210 and 230 or plies 230 and 220 as a melt curtain, e.g., just before the nip of lamination rollers for laminating the respective pair of adjacent plies 210 and 230 or plies 230 and 220.

The three plies 210, 230, and 220 can be laminated simultaneously in a single production line or sequentially by laminating two adjacent plies in a first laminating step to produce an intermediate laminated structure, followed by laminating the remaining ply to the intermediate laminated structure in a second lamination step.

With reference now to FIG. 3, a third embodiment packaging film structure 300 includes an outer film ply 310 which is laminated to a first intermediate film ply 330 via a first bonding interlayer 316a which is disposed intermediate the outer and first intermediate plies 310 and 330, respectively. The outer film ply 310 is an exterior film ply and the first intermediate film ply 330 is an interior film ply.

The first intermediate film ply 330 is, in turn, laminated to a second intermediate film ply 340 via a second bonding interlayer 316b which is disposed intermediate the first and second intermediate plies 330 and 340, respectively. The second intermediate film ply 340 is an interior film ply.

The second intermediate film ply 340 is, in turn, laminated to an inner film ply 320 via a third bonding interlayer 316c which is disposed intermediate the first intermediate and inner plies 330 and 320, respectively. The inner film ply 320 is an inner and exterior film ply

The first bonding interlayer 316a is interposed between the outer film ply 310 and the first intermediate film ply 330; the second bonding interlayer 316b is interposed between the first intermediate film ply 330 and the second intermediate film ply 340; and the third bonding interlayer 316c is interposed between the second intermediate film ply 340 and the inner film ply 320 to form a laminated structure. In certain embodiments, the bonding interlayers 316a, 316b, and 316c, which can be the same or different, are independently selected from an adhesive layer and an extruded polymer interlayer, which can be as described above by way of reference to the bonding interlayer 116 appearing in FIG. 1.

The outer ply 310 comprises an outer layer 312, which may be as described above by way of reference to the outer layer 112 appearing in FIG. 1.

The inner ply 320 includes a polymer-based film layer 322, wherein the inner film ply 320 and the polymer-based film layer 322 may be as described above by way of reference to the inner film ply 120 and the polymer-based film layer 122 appearing in FIG. 1.

The first intermediate ply 330 includes a polymer-based film layer 332, wherein the first intermediate ply 330 and the polymer-based film layer 332 may be as described above by way of reference to the intermediate film ply 230 and the polymer-based film layer 322 appearing in FIG. 2.

The second intermediate ply 340 includes a second intermediate polymer based film layer 342, which may be a monolayer or multilayer structure and optionally includes a moisture vapor barrier layer, an oxygen barrier layer, or both.

In embodiments, the polymer-based film layer 342 comprises a nonpolar polymer admixed with a multifunctional polyolefin-based compatibilizer. The amount of multifunctional compatibilizer to be added to the nonpolar polymer depends on the concentration of polar groups present in the overall structure 300. It will be recognized that polar groups are present not only in the outer layer 312 as described above, but also, also in any optional barrier layer in the inner ply 320 and any optional barrier layer in the first and second intermediate plies 330, 340. As described below, the polymer-based film 342 may include one or more polar polymer barrier layers, such as EVOH, polyamide, and PVOH. In embodiments, the multifunctional compatibilizer is present in an amount ranging from about 0.5% to about 10% by weight based on the weight of the structure 300, e.g., about 0.5% 1.0%, 1.5%, 2.0%, 2.5%, 3.0%, 3.5%, 4.0%, 4.5%, 5.0%, 5.5%, 6.0%, 6.5%, 7.0%, 7.5%, 8.0%, 8.5%, 9.0%, 9.5%, and 10%, or within any subrange thereof. In preferred embodiments, the multifunctional compatibilizer is present in an amount ranging from about 1% to about 4% by weight based on the weight of the structure 300.

The polymer-based film layer 342 comprises a monolayer or multilayer structure. In embodiments, the nonpolar polymer component(s) of the polymer-based film layer 342 is a polyolefin-based polymer. Examples of polyolefin-based polymers include polyethylene (PE), polypropylene (PP), polyolefin blends, or polyolefin copolymers. In embodiments, the nonpolar polymer component(s) of the polymer-based film layer 342 comprises low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cast polypropylene (CPP), ethylene-propylene copolymer (EPC), monoaxially- and biaxially-oriented polyolefins including without limitation biaxially oriented polypropylene (BOPP), and other polyolefin materials, including post-consumer recycled (PCR) polyolefins, as well as blends, coextrusions, and laminations of any of the foregoing, provided that at least the exterior most layer is a heat sealable polyolefin layer. In embodiments, the nonpolar polymer component(s) of the polymer-based film layer 342 may be a copolymer of polyethylene and polypropylene, such as an ethylene-propylene copolymer or cyclic olefin copolymers (COC). In embodiments, the nonpolar polymer component(s) of the polymer-based film layer 342 may be a coextruded film with a barrier layer and optional tic resin layers as would be understood by persons skilled in the art. In embodiments, the barrier layer is selected from ethylene vinyl alcohol (EVOH), polyamide (PA), such as nylon 6, nylon 66, nylon 6/66, PVOH, and the like.

In certain embodiments, an optional ink layer 324a is disposed on the outward facing surface of the outer layer 312. The ink layer 324a may be as described above by way of reference to the ink layer 124a appearing in FIG. 1.

In certain embodiments, an optional ink layer 324b is disposed on the inward facing surface of the outer layer 312. The ink layer 324b may be as described above by way of reference to the ink layer 124b appearing in FIG. 1.

In certain embodiments, an optional ink layer 324c is disposed on the outward facing surface of the polymer-based film layer 322. The ink layer 324c may be as described above by way of reference to the ink layer 124c appearing in FIG. 1.

In certain embodiments, an optional ink layer 324d is disposed on the outward facing surface of the polymer-based film layer 332. The ink layer 324d may be as described above by way of reference to the ink layer 224d appearing in FIG. 2.

In certain embodiments, an optional ink layer 324e is disposed on the inward facing surface of the polymer-based film layer 332. The ink layer 324e may be as described above by way of reference to the ink layer 224e appearing in FIG. 2.

In certain embodiments, an optional ink layer 324f is disposed on the outward facing surface of the polymer-based film layer 342. The ink layer 324f provides printed indicia intended to appear on a packaging structure formed from the film structure 300. Because the printing ink layer 324f is applied to the outward facing surface of the polymer-based film layer 342, the printed material is effected in a forward printed format. The printing ink layer 324f can be applied to the outer surface of the polymer-based film layer 342 via any conventional printing method as would be understood by persons skilled in the art, including without limitation, using a rotogravure printing apparatus, flexographic printing apparatus, offset printing apparatus, digital printing apparatus, ink jet printing apparatus, and the like.

In certain embodiments, an optional ink layer 324g is disposed on the inward facing surface of the polymer-based film layer 342. The ink layer 324g provides printed indicia intended to appear on a packaging structure formed from the film structure 300. Because the printing ink layer 324g is applied to the inward facing surface of the polymer-based film layer 342, the printed material is effected in a reverse (mirror image) printed format. The printing ink layer 324g can be applied to the inner surface of the polymer-based film layer 342 via any conventional printing method as would be understood by persons skilled in the art, including without limitation, using a rotogravure printing apparatus, flexographic printing apparatus, offset printing apparatus, digital printing apparatus, ink jet printing apparatus, and the like.

While FIG. 3 illustrates potential configurations with ink layers 324a depicted on the outer surface of the outer layer 312, 324b depicted on the inner surface of the outer layer 312, 324c depicted on the outward facing surface of the polymer-based film layer 322, 324d depicted on the outer surface of the first intermediate layer 332, 324e depicted on the inner surface of the first intermediate layer 232 for case of illustration, 324f depicted on the outer surface of the second intermediate layer 342, and 324g depicted on the inner surface of the second intermediate layer 342 for case of illustration, it should be understood that in practical embodiments of the film structure 300, a printed ink layer will typically be applied at only one of these locations. The selection of the location of the ink layer may depend on factors such as desired aesthetics, functional requirements, or manufacturing considerations.

The structure 300 can be formed using conventional lamination techniques, such as adhesive lamination or extrusion lamination techniques. When the bonding interlayers 316a, 316b, 316c, which are independent of each other and can be the same or different, are adhesive layers, the adhesive is applied between the respective pair of plies 310 and 330, plies 330 and 340, or 340 and 320 and bonded under suitable conditions. The adhesive may be applied to either or both facing surfaces to be bonded via any suitable coating method, such as spray coating, roll coating, blade coating, or similar techniques. When the bonding interlayers 316a, 316b, 316c are extrusion interlayers, the bonding interlayer is extruded onto a surface of the respective pair of plies 310 and 330, plies 330 and 340, or 340 and 320 as a melt curtain, e.g., just before the nip of lamination rollers for laminating the respective pair of plies 310 and 330, plies 330 and 340, or 340 and 320.

The four plies 310, 330, 340, and 320 can be laminated simultaneously in a single production line or sequentially in multiple steps. For example, in embodiments, adjacent plies are laminated in a first laminating step to produce an intermediate laminated structure, followed by laminating the remaining plies to the intermediate laminated structure in subsequent lamination steps. For instance, two adjacent plies (e.g., 310, 320) can be laminated first to form a partial structure, which is then laminated with a third ply (e.g., 340) in a second step, and finally with the fourth ply (e.g., 320) in a third step. Alternatively, three adjacent plies (e.g., 310, 330, 340) can be laminated first to form an intermediate structure, which is then laminated with the fourth ply (e.g., 320) in a subsequent step. Another approach involves laminating one pair of plies (e.g., 310, 330) in a first step, and another pair of plies (e.g., 340, 320) in a second step, and then laminating the resulting laminated pairs in a third step to produce the final four-ply structure 300.

It will be recognized that the present development is not limited to 4 ply structures and that further embodiments comprising additional intermediate plies are also contemplated.

Referring now to FIG. 4, there is shown a film layer 450, which illustrates an exemplary layer which may embody any one or more of the polymer-based film layers 122, 222, 232, 322, 332, and 342. The film layer 450 comprises a polyolefin-based polymer layer 452, which may be a monolayer or multilayer structure, comprising a polyolefin polymer (as described above) admixed with a multifunctional compatibilizer.

The multifunctional compatibilizer comprises a polyolefin-based polymer or copolymer system which has at least two different functional groups. The polyolefin-based polymer system preferably comprises polyethylene, polypropylene, or blends or copolymers thereof. The presence of two or more different functional groups allows the compatibilizer to exhibit a broader range of compatibilization properties between different polar polymers and non-polar polyolefins. In embodiments, the multifunctional compatibilizer comprises (a) a polyolefin-based polymer system which is functionalized with two or more different functional groups on the same polymer chain or molecule; (b) a blend of two or more polyolefin-based polymers, each of which is functionalized with a different functional group; (c) a copolymer comprising monomer units derived from at least two monomers having different functional groups; and (d) a combination thereof.

In embodiments, the multifunctional compatibilizer comprises a polyolefin-based polymer system which is functionalized with at least two functional groups selected from the group consisting of a carboxylic acid, an ester, an anhydride, an aldehyde, a ketone, an isocyanate, an epoxide, an acrylate, an alkene, an alkyne, a nitroso, an imide, a carbonate, a nitrile, an acid halide, such as an acid chloride, a phosphoric acid derivative, including esters, anhydrides and salts of phosphoric acid, an alkyl halide, a sulfonyl halide, such as a sulfonyl chloride, an aziridine, a halogen, such as chlorine, bromine, and iodine, a carbene, and a sulfonic acid group.

In preferred embodiments, the multifunctional compatibilizer comprises a polyolefin-based polymer system which is functionalized with at least two functional groups selected from the group consisting of a carboxylic acid, an ester, an anhydride, an aldehyde, a ketone, an isocyanate, an epoxide, an alkene, an alkyne, and a nitroso group.

In certain embodiments, the multifunctional compatibilizer is a low molecular weight compatibilizer, e.g., wherein the molecular weight is below about 50,000 g/mol. In certain embodiments, the multifunctional compatibilizer is a medium molecular weight compatibilizer, e.g., wherein the molecular weight is in the range of from about 50,000 g/mol to about 200,000 g/mol. In certain embodiments, the multifunctional compatibilizer is a high molecular weight compatibilizer, e.g., wherein the molecular weight is in the range of from about 200,000 g/mol to about 3,000,000 g/mol. In certain embodiments, the multifunctional compatibilizer is an ultra-high molecular weight compatibilizer, e.g., wherein the molecular weight is above about 3,000,000 g/mol, e.g., up to about 10,000,000 g/mol or higher, depending on synthesis and processing constraints.

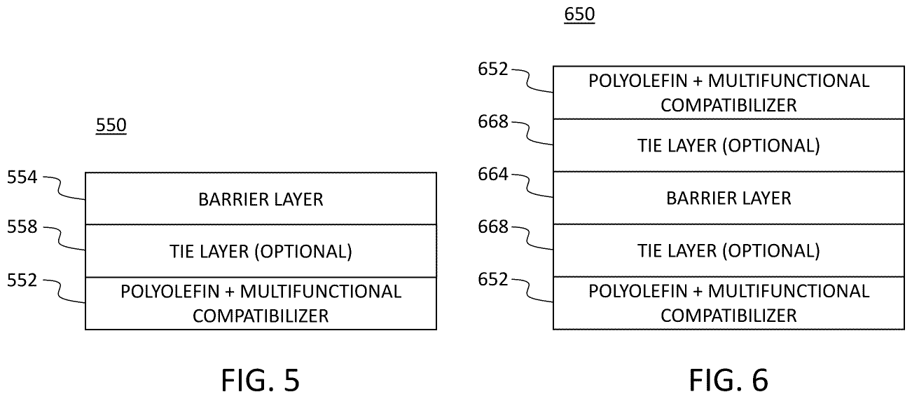

Referring now to FIG. 5, there is shown a film layer 550, which illustrates an exemplary barrier film layer which may embody any one or more of the polymer-based film layers 122, 222, 232, 322, 332, and 342. The film layer 550 comprises a layer 552 comprising polyolefin-based polymer admixed with a multifunctional compatibilizer, wherein the layer 552 is as described above by way of reference to the layer 452 appearing in FIG. 4.

The film layer 552 acts as a substrate having a gas (e.g., oxygen), and/or moisture barrier layer 554 disposed on a major surface thereof. In embodiments, the barrier layer 554 is metal oxide coating layer, such as aluminum oxide (AlOx), silicon oxide (SiOx), or a mixture thereof. The metal oxide coating layer may be deposited using physical or chemical deposition techniques or a solution coating technique.

In embodiments, the barrier layer 554 is metallization coating layer, such as an aluminum metallization layer. The metallization coating layer may be deposited using physical or chemical deposition techniques. In further embodiments, the barrier layer 554 comprises a polymeric oxygen/gas and/or moisture barrier composition, such as polyvinyl alcohol (PVOH), EVOH, and polyamide (PA, e.g., nylon 6, nylon 66, nylon 6/66, nylon 12, and blends and copolymers thereof). In embodiments, the barrier layer 554 may comprise a multilayer structure, such as PA/EVOH/PA (with or without optional tic layers) or PA/PVOH/PA (with or without optional tie layers). In further embodiments, the barrier layer 554 comprises a metal, e.g., aluminum, foil layer.

In certain embodiments, the film layer 550 has structure, as follows, wherein optional tie resin layers (“tie”) may be provided to promote adhesion between adjacent layers:

$$barrier / polyolefin + multifunctional compatibilizer ( MFC )$$

wherein the barrier layer is applied directly to the paper layer and the polyolefin layer is disposed on the barrier layer. Optional tie resin layers (“tie”) may be provided to promote adhesion between adjacent layers.

Examples of such multilayer structures include:

$$AlO x / PE + MFC$$

$$AlO x / PP + MFC$$

$$SiO x / PE + MFC$$

$$SiO x / PP + MFC$$

$$metal / PE + MFC$$

$$metal / PP + MFC$$

$$EVOH / PE + MFC$$

$$EVOH / PP + MFC$$

$$EVOH / tie / PE + MFC$$

$$EVOH / tie / PP + MFC$$

$$PA / PE + MFC$$

$$PA / PP + MFC$$

$$PA / tie / PE + MFC$$

$$PA / tie / PP + MFC$$

$$PA / EVOH / PA / PE + MFC$$

$$PA / EVOH / PA / PP + MFC$$

$$PA / EVOH / PA / tie / PE + MFC$$

$$PA / EVOH / PA / tie / PP + MFC$$

$$PA / tie / EVOH / PA / PE + MFC$$

$$PA / tie / EVOH / PA / PP + MFC$$

$$PA / tie / EVOH / PA / tie / PE + MFC$$

$$PA / tie / EVOH / PA / tie / PP + MFC$$

$$PA / tie / EVOH / tie / PA / PE + MFC$$

$$PA / tie / EVOH / tie / PA / PP + MFC$$

$$PA / tie / EVOH / tie / PA / tie / PE + MFC$$

$$PA / tie / EVOH / tie / PA / tie / PP + MFC$$

$$PA / EVOH / tie / PA / PE + MFC$$

$$PA / EVOH / tie / PA / PP + MFC$$

$$PA / EVOH / tie / PA / tie / PE + MFC$$

$$PA / EVOH / tie / PA / tie / PP + MFC$$

$$PA / EVOH / PE + MFC$$

$$PA / EVOH / PP + MFC$$

$$PA / EVOH / tie / PE + MFC$$

$$PA / EVOH / tie / PP + MFC$$

$$PA / tie / EVOH / PE + MFC$$

$$PA / tie / EVOH / PP + MFC$$

$$PA / tie / EVOH / tie / PE + MFC$$

$$PA / tie / EVOH / tie / PP + MFC$$

$$EVOH / PA / PE + MFC$$

$$EVOH / PA / PP + MFC$$

$$EVOH / PA / tie / PE + MFC$$

$$EVOH / PA / tie / PP + MFC$$

$$EVOH / tie / PA / PE + MFC$$

$$EVOH / tie / PA / PP + MFC$$

$$EVOH / tie / PA / tie / PE + MFC$$

$$EVOH / tie / PA / tie / PP + MFC$$

$$PVOH / PE + MFC$$

$$PVOH / PP + MFC$$

$$PVOH / tie / PE + MFC$$

$$PVOH / tie / PP + MFC$$

$$PA / PVOH / PA / PE + MFC$$

$$PA / PVOH / PA / PP + MFC$$

$$PA / PVOH / PA / tie / PE + MFC$$

$$PA / PVOH / PA / tie / PP + MFC$$

$$PA / tie / PVOH / PA / PE + MFC$$

$$PA / tie / PVOH / PA / PP + MFC$$

$$PA / tie / PVOH / PA / tie / PE + MFC$$

$$PA / tie / PVOH / PA / tie / PP + MFC$$

$$PA / tie / PVOH / tie / PA / PE + MFC$$

$$PA / tie / PVOH / tie / PA / PP + MFC$$

$$PA / tie / PVOH / tie / PA / tie / PE + MFC$$

$$PA / tie / PVOH / tie / PA / tie / PP + MFC$$

$$PA / PVOH / tie / PA / PE + MFC$$

$$PA / PVOH / tie / PA / PP + MFC$$

$$PA / PVOH / tie / PA / tie / PE + MFC$$

$$PA / PVOH / tie / PA / tie / PP + MFC$$

$$PA / PVOH / PE + MFC$$

$$PA / PVOH / PP + MFC$$

$$PA / PVOH / tie / PE + MFC$$

$$PA / PVOH / tie / PP + MFC$$

$$PA / tie / PVOH / PE + MFC$$

$$PA / tie / PVOH / PP + MFC$$

$$PA / tie / PVOH / tie / PE + MFC$$

$$PA / tie / PVOH / tie / PP + MFC$$

$$PVOH / PA / PE + MFC$$

$$PVOH / PA / PP + MFC$$

$$PVOH / PA / tie / PE + MFC$$

$$PVOH / PA / tie / PP + MFC$$

$$PVOH / tie / PA / PE + MFC$$

$$PVOH / tie / PA / PP + MFC$$

$$PVOH / tie / PA / tie / PE + MFC$$

$$PVOH / tie / PA / tie / PP + MFC$$

When the layer 450 is in an interior ply such as the intermediate ply 230 (see FIG. 2), the first intermediate ply 330 (see FIG. 3), or the second intermediate ply 340 (see FIG. 3), the barrier layer 554 may be disposed on the interior or exterior facing side of the substrate layer 452. When the layer 450 is in an exterior ply such as the outer ply 110 or inner ply 120 (see FIG. 1), the outer ply 210 or the inner ply 220 (see FIG. 2), or the inner ply 310 or the inner ply 320 (see FIG. 3), the barrier layer 554 is preferably disposed on the interior facing surface of the substrate layer 452.

Referring now to FIG. 6, there is shown a coextruded a film layer 650, which illustrates an exemplary barrier film layer operable to embody any one or more of the polymer-based film layers 122, 222, 232, 322, 332, and 342. The film layer 650 comprises a barrier layer 664 coextruded between two compatibilizer layers 652 comprising a polyolefin-based polymer admixed with a multifunctional compatibilizer. The layers 652 may be as described above by way of reference to the layer 552 appearing in FIG. 5. In embodiments, the barrier layer 654 comprises a polymer selected from ethylene vinyl alcohol copolymer (EVOH), a polyamide (PA), such as nylon 6, nylon 66, nylon 6/66, PVOH, or any combination thereof. Optional tie layers 668 comprising a tie resin may be provided between the adjacent layers 652 and 664 to facilitates adhesion between the layers. Such tie resins may include any suitable tie resin as is known to persons skilled in the for art, including for example, maleic anhydride grafted polyolefins, such as maleic anhydride grafted polyethylene (PE-g-MA), maleic anhydride grafted polypropylene (PE-g-MA), ethylene-acrylic acid copolymers (EAA), ethylene-methyl acrylate (EMA) copolymers, and the like.

In certain embodiments, the coextruded a film layer 650 has the following structure, wherein optional tie layers (“tie”) may be provided to promote adhesion between adjacent layers:

$$polyolefin + MFC / barrier / polyolefin + MFC$$

Exemplary polyolefins include polyethylene (PE) and polypropylene (PP). Exemplary barriers include ethylene vinyl alcohol copolymer (EVOH) polyvinyl alcohol (PVOH), and/or polyamide (PA). Exemplary polyamides include nylon, such as nylon 6, nylon 66, nylon 6/66, nylon 12, and blends and copolymers thereof. Examples of such film layer 650 include:

$$PE + MFC / EVOH / PE + MFC$$

$$PE + MFC / PA / PE + MFC$$

$$PP + MFC / EVOH / PP + MFC$$

$$PP + MFC / PA / PP + MFC$$

$$PE + MFC / tie / EVOH / tie / PE + MFC$$

$$PE + MFC / tie / PA / tie / PE + MFC$$

$$PP + MFC / tie / EVOH / tie / PP + MFC$$

$$PP + MFC / tie / PA / tie / PP + MFC$$

$$PE + MFC / PA / EVOH / PA / PE + MFC$$

$$PP + MFC / PA / EVOH / PA / PP + MFC$$

$$PE + MFC / PA / tie / EVOH / tie / PA / PE + MFC$$

$$PP + MFC / PA / tie / EVOH / tie / PA / PP + MFC$$

$$PE + MFC / tie / PA / EVOH / PA / tie / PE + MFC$$

$$PP + MFC / tie / PA / EVOH / PA / tie / PP + MFC$$

$$PE + MFC / tie / PA / tie / EVOH / tie / PA / tie / PE + MFC$$

$$PP + MFC / tie / PA / tie / EVOH / tie / PA / tie / PP + MFC$$

$$PE + MFC / PVOH / PE + MFC$$

$$PP + MFC / PVOH / PP + MFC$$

$$PE + MFC / tie / PVOH / tie / PE + MFC$$

$$PP + MFC / tie / PVOH / tie / PP + MFC$$

$$PE + MFC / PA / PVOH / PA / PE + MFC$$

$$PP + MFC / PA / PVOH / PA / PP + MFC$$

$$PE + MFC / PA / tie / PVOH / tie / PA / PE + MFC$$

$$PP + MFC / PA / tie / PVOH / tie / PA / PP + MFC$$

$$PE + MFC / tie / PA / PVOH / PA / tie / PE + MFC$$

$$PP + MFC / tie / PA / PVOH / PA / tie / PP + MFC$$

$$PE + MFC / tie / PA / tie / PVOH / tie / PA / tie / PE + MFC$$

$$PP + MFC / tie / PA / tie / PVOH / tie / PA / tie / PP + MFC$$

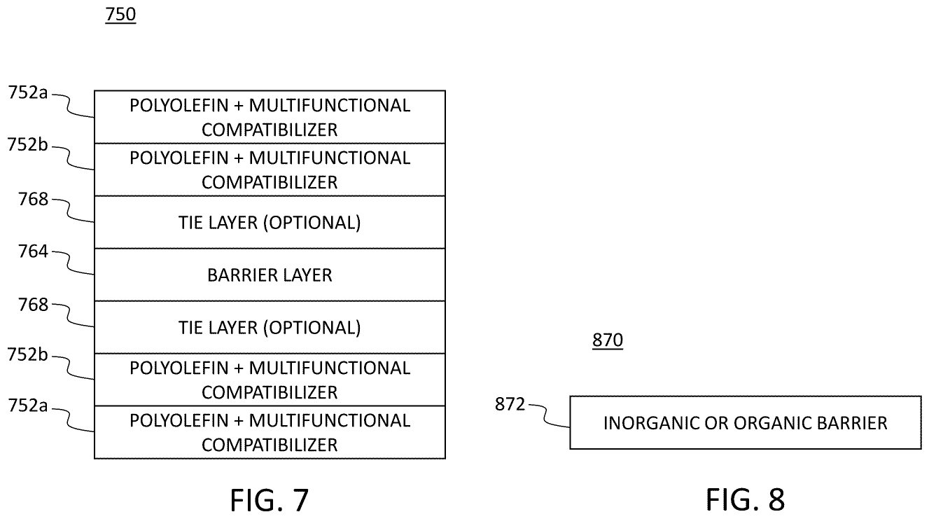

Referring now to FIG. 7, there is shown a coextruded a film layer 750, which illustrates an exemplary barrier film layer operable to embody any one or more of the polymer-based film layers 122, 222, 232, 322, 332, and 342. The film layer 750 comprises a barrier layer 764 coextruded between dual compatibilizer layers 752a and 752b comprising a polyolefin-based polymer admixed with a multifunctional compatibilizer disposed on each side of the barrier layer 764. The layers 752a and 752b may be as described above by way of reference to the layer 552 appearing in FIG. 5. In embodiments, the barrier layer 764 comprises a polymer selected from ethylene vinyl alcohol copolymer (EVOH), a polyamide (PA), such as nylon 6, nylon 66, nylon 6/66, PVOH, or any combination thereof. Optional tie layers 768 comprising a tie resin may be provided between the adjacent layers 752b and 764 to facilitates adhesion between the layers. Such tie resins may include any suitable tie resin as is known to persons skilled in the for art, including for example, maleic anhydride grafted polyolefins, such as maleic anhydride grafted polyethylene (PE-g-MA), maleic anhydride grafted polypropylene (PE-g-MA), ethylene-acrylic acid copolymers (EAA), ethylene-methyl acrylate (EMA) copolymers, and the like.

In certain embodiments, the coextruded a film layer 750 has the following structure, wherein optional tie layers (“tie”) may be provided to promote adhesion between adjacent layers:

$$polyolefin + MFC / polyolefin + MFC / barrier / polyolefin + MFC / polyolefin + MFC$$

Exemplary polyolefins include polyethylene (PE) and polypropylene (PP). Exemplary barriers include ethylene vinyl alcohol copolymer (EVOH) and/or polyamide (PA). Exemplary polyamides include nylon, such as nylon 6, nylon 66, nylon 6/66, nylon 12, and blends and copolymers thereof. Examples of such film layer 750 include:

$$PE + MFC / PE + MFC / EVOH / PE + MFC / PE + MFC$$

$$PE + MFC / PE + MFC / PA / PE + MFC / PE + MFC$$

$$PP + MFC / PP + MFC / EVOH / PP + MFC / PP + MFC$$

$$PP + MFC / PP + MFC / PA / PP + MFC / PP + MFC$$

$$PE + MFC / PE + MFC / tie / EVOH / tie / PE + MFC / PE + MFC$$

$$PE + MFC / PE + MFC / tie / PA / tie / PE + MFC / PE + MFC$$

$$PP + MFC / PP + MFC / tie / EVOH / tie / PP + MFC / PP + MFC$$

$$PP + MFC / PP + MFC / tie / PA / tie / PP + MFC / PP + MFC$$

$$PE + MFC / PE + MFC / PA / EVOH / PA / PE + MFC / PE + MFC$$

$$PP + MFC / PP + MFC / PA / EVOH / PA / PP + MFC / PP + MFC$$

$$PE + MFC / PE + MFC / PA / tie / EVOH / tie / PA / PE + MFC / PE + MFC$$

$$PP + MFC / PP + MFC / PA / tie / EVOH / tie / PA / PP + MFC / PP + MFC$$

$$PE + MFC / PE + MFC / tie / PA / EVOH / PA / tie / PE + MFC / PE + MFC$$

$$PP + MFC / PP + MFC / tie / PA / EVOH / PA / tie / PP + MFC / PP + MFC$$

$$PE + MFC / PE + MFC / tie / PA / tie / EVOH / tie / PA / tie / PE + MFC / PE + MFC$$

$$PP + MFC / PP + MFC / tie / PA / tie / EVOH / tie / PA / tie / PP + MFC / PP + MFC$$

$$PE + MFC / PE + MFC / PA / PVOH / PA / PE + MFC / PE + MFC$$

$$PP + MFC / PP + MFC / PA / PVOH / PA / PP + MFC / PP + MFC$$

$$PE + MFC / PE + MFC / PA / tie / PVOH / tie / PA / PE + MFC / PE + MFC$$

$$PP + MFC / PP + MFC / PA / tie / PVOH / tie / PA / PP + MFC / PP + MFC$$

$$PE + MFC / PE + MFC / tie / PA / PVOH / PA / tie / PE + MFC / PE + MFC$$

$$PP + MFC / PP + MFC / tie / PA / PVOH / PA / tie / PP + MFC / PP + MFC$$

$$PE + MFC / PE + MFC / tie / PA / tie / PVOH / tie / PA / tie / PE + MFC / PE + MFC$$

$$PP + MFC / PP + MFC / tie / PA / tie / PVOH / tie / PA / tie / PP + MFC / PP + MFC$$

Referring now to FIG. 8, there is shown a layer 870, which may be a film layer or coating layer, which illustrates an exemplary barrier layer which may embody the barrier layers 554, 664, 764, and 1394 appearing in FIGS. 5-7, and 13, respectively. The film layer 870 may comprise an organic or inorganic barrier layer, as described above. In certain embodiments, the barrier layer 870 comprises a metallization coating layer, such as an aluminum metallization layer. The metallization coating layer may be deposited using physical or chemical deposition techniques. In further embodiments, the barrier layer 870 comprises a polymeric oxygen/gas and/or moisture barrier composition, such as polyvinyl alcohol (PVOH), EVOH, and polyamide (PA, e.g., nylon 6, nylon 66, nylon 6/66, nylon 12, and blends and copolymers thereof).

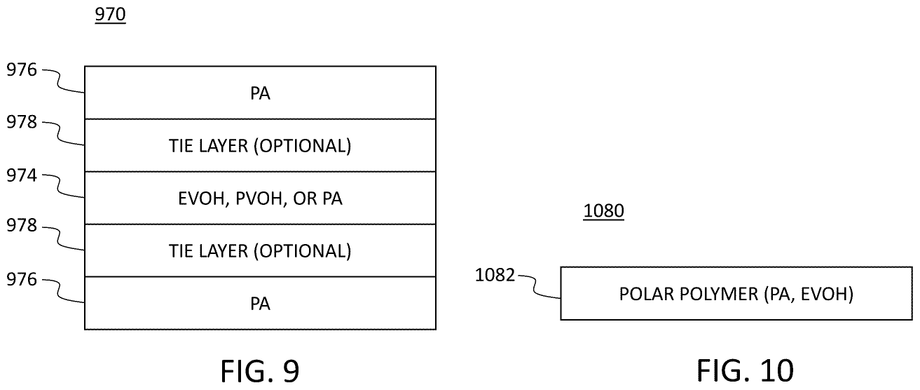

Referring now to FIG. 9, there is shown a layer 970, which may be a coextruded film layer, which illustrates a further exemplary barrier layer which may embody the barrier layers 554, 664, 764, and 1394 appearing in FIGS. 5-7, and 13, respectively. The film layer 970 may comprise a coextruded organic barrier layer comprising a middle barrier layer 974 comprising a polymeric oxygen/gas and/or moisture barrier composition, such as polyvinyl alcohol (PVOH), EVOH, and polyamide (PA, e.g., nylon 6, nylon 66, nylon 6/66, nylon 12, and blends and copolymers thereof). The middle barrier layer 974 is positioned between two outer barrier layers 976. In embodiments, the outer barrier layers 976 comprise a polyamide, such as nylon 6, nylon 66, nylon 6/66, nylon 12, and blends and copolymers thereof. Optionally, tie layers 978 may be included between the middle barrier layer 974 and the outer barrier layers 976 to promote adhesion therebetween.

Referring now to FIG. 10, there is shown a film layer 1080, which illustrates an exemplary layer which may embody the outer layer 112, 212, and 312 appearing in FIGS. 1-3. The film layer 1080 comprises a polar polymer layer 1082, which may be a monolayer or multilayer structure, comprising one or more polar polymers as described above. In preferred embodiment, the polar polymer is selected from the group consisting of a polyamide and an ethylene-vinyl alcohol copolymer (EVOH).

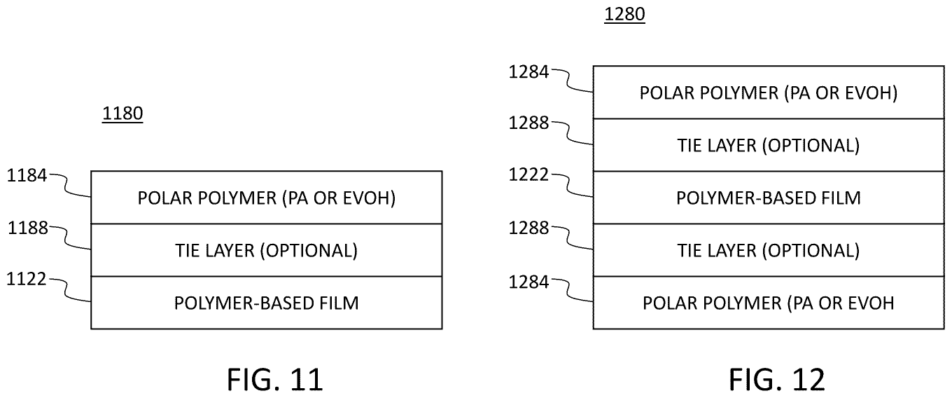

Referring now to FIG. 11, there is shown a film layer 1180, which illustrates another exemplary layer which may embody the outer layer 112, 212, and 312 appearing in FIGS. 1-3. The film layer 1180 comprises a polar polymer layer 1184, which may be a monolayer or multilayer structure, comprising one or more polar polymers as described above. In preferred embodiment, the polar polymer is selected from the group consisting of a polyamide and an ethylene-vinyl alcohol copolymer (EVOH). A polymer based film layer 1122 is disposed on the inner surface of the layer 1184. An optional tie layer 1188 may be provided to enhance adhesion.

In embodiments, the structure 1180 may be produced using a coextrusion process wherein the polar polymer layer 1184, polymer-based film layer 1122 and optional tic layer 1188 are coextruded layers. In alternative embodiments, the polar polymer layer 1184 and optional tie layer 1188 are extruded/coextruded via an extrusion coating process onto a polymer-based film substrate 1122. In still further embodiments, the polymer-based film substrate 1122 and optional tie layer 1188 are extruded/coextruded via an extrusion coating process onto a polar polymer layer substrate 1184.

Referring now to FIG. 12 there is shown a film layer 1280, which illustrates another exemplary layer which may embody the outer layer 112, 212, and 312 appearing in FIGS. 1-3. The film layer 1280 comprises first and second polar polymer layers 1284, each of which may be a monolayer or multilayer structure, comprising one or more polar polymers as described above. In preferred embodiment, the polar polymer is selected from the group consisting of a polyamide and an ethylene-vinyl alcohol copolymer (EVOH). The first and second polar polymer layers 1284 are disposed on opposing sides of a polymer based film layer 1222. Optional tie layers 1288 may be provided intermediate the polymer based film layer 1222 and the polar polymer layers 1284 to enhance adhesion therebetween.

In embodiments, the structure 1280 may be produced using a coextrusion process wherein the polar polymer layers 1284, the polymer-based film layer 1222, and optional tie layers 1288 are coextruded layers. However, it is contemplated that other lamination techniques, including but not limited to extrusion coating and coextrusion coating methods, may also be employed to fabricate the structure 1280.

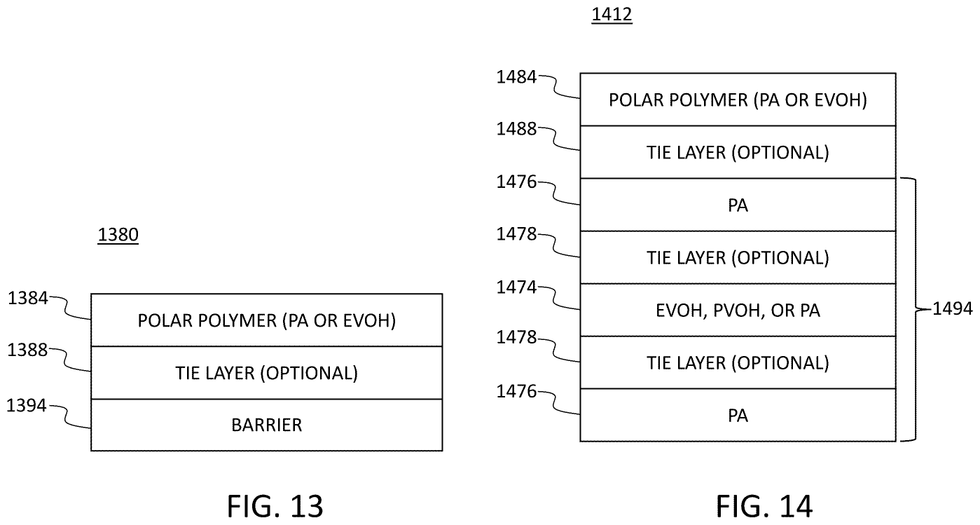

Referring now to FIG. 13 there is shown a film layer 1380, which illustrates another exemplary layer which may embody the outer layer 112, 212, and 312 appearing in FIGS. 1-3. The film layer 1380 comprises a polar polymer layer 1384, which may be a monolayer or multilayer structure, comprising one or more polar polymers as described above. In preferred embodiment, the polar polymer is selected from the group consisting of a polyamide and an ethylene-vinyl alcohol copolymer (EVOH). A barrier layer 1394 is disposed on the inward surface of the polar polymer layer 1384. An optional tie layer 1388 may be provided intermediate the polar polymer layer 1384 and the barrier layer 1394 to enhance adhesion therebetween.

The barrier layer 1394 may comprise an organic or inorganic barrier layer, as described above by way of reference to FIGS. 8 and 9. In certain embodiments, the barrier layer 1394 comprises a metallization coating layer, such as an aluminum metallization layer. The metallization coating layer may be deposited using physical or chemical deposition techniques. In further embodiments, the barrier layer 1394 comprises a polymeric oxygen/gas and/or moisture barrier composition, such as polyvinyl alcohol (PVOH), EVOH, and polyamide (PA, e.g., nylon 6, nylon 66, nylon 6/66, nylon 12, and blends and copolymers thereof).

Referring now to FIG. 14, in certain embodiments, there is shown an outer layer barrier structure 1412 comprising a barrier layer 1494 which comprises a multilayer film which is as described above by way of reference to FIG. 9, which includes a multilayer, e.g., coextruded, organic barrier layer comprising a middle barrier layer 1474 comprising a polymeric oxygen/gas and/or moisture barrier composition, such as polyvinyl alcohol (PVOH), EVOH, and polyamide (PA, e.g., nylon 6, nylon 66, nylon 6/66, nylon 12, and blends and copolymers thereof). The middle barrier layer 1474 is positioned between two outer barrier layers 1476. In embodiments, the outer barrier layers 1476 comprise a polyamide, such as nylon 6, nylon 66, nylon 6/66, nylon 12, and blends and copolymers thereof. Optionally, tie layers 1478 may be included between the middle barrier layer 1474 and the outer barrier layers 1476 to promote adhesion therebetween.

The multilayer barrier 1494 is attached to the inward facing surface of a polar polymer layer 1484, either directly or with a tie layer 1488 therebetween to promote adhesion. The polar polymer layer 1484 may be a monolayer or multilayer structure, comprising one or more polar polymers as described above. In preferred embodiment, the polar polymer is selected from the group consisting of a polyamide and an ethylene-vinyl alcohol copolymer (EVOH).

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A laminated recyclable polyolefin-based film structure comprising:
an outer layer comprising a polar polymer; and
at least one polymer-based film layer comprising a polyolefin polymer and a multifunctional polar polymer compatibilizer, wherein the multifunctional polar polymer compatibilizer comprises a polyolefin with at least two different functional groups.

2. The film structure of claim 1, wherein the outer layer comprises a film selected from the group consisting of oriented polar polymer film, a cast polar polymer film, and a blow polar polymer film.

3. The film structure of claim 1, wherein the at least one polymer-based film layer comprises an inner sealant layer laminated to the oriented film outer layer with a bonding interlayer selected from an adhesive layer and an extrusion interlayer.

4. The film structure of claim 1, wherein the at least one polymer-based film layer comprises an inner sealant layer and at least one intermediate film layer disposed between the oriented film outer layer and the inner sealant layer.

5. The film structure of claim 4, wherein the oriented film outer layer is laminated to the at least one intermediate film layer with a first bonding interlayer selected from an adhesive layer and an extrusion interlayer, and wherein the at least one intermediate film layer is laminated to the inner sealant layer with a second bonding interlayer selected from an adhesive layer and an extrusion interlayer.

6. The film structure of claim 1, wherein the at least one polymer-based film layer comprises an inner sealant layer, a first intermediate film layer, and a second intermediate film layer, wherein the first intermediate film layer is disposed between the oriented film outer layer and the second intermediate film layer, and wherein the second intermediate film layer is disposed between the first intermediate film layer and the inner sealant layer.

7. The film structure of claim 6, wherein the oriented film outer layer is laminated to the first intermediate film layer with a first bonding interlayer selected from an adhesive layer and an extrusion interlayer, wherein the first intermediate film layer is laminated to the second intermediate film layer with a second bonding interlayer selected from an adhesive layer and an extrusion interlayer, and wherein the second intermediate film layer is laminated to the inner sealant layer with a third bonding interlayer selected from an adhesive layer and an extrusion interlayer.

8. The film structure of claim 1, wherein the oriented film outer layer comprises a polymer selected from the group consisting of a one or more polyamides and one or more polyesters.

9. The film structure of claim 1, wherein the oriented film outer layer is formed of a film selected from the group consisting of biaxially oriented nylon (BON), cast nylon, oriented polyethylene terephthalate (OPET), and biaxially oriented polyethylene terephthalate (BOPET).

10. The film structure of claim 9, wherein the oriented film outer layer comprises post-consumer recycled (PCR) material, the PCR material being present in an amount of up to 100% by weight of the oriented film outer layer.

11. The film structure of claim 1, further comprising a barrier layer disposed on at least one of the at least one polymer-based film layer.

12. The film structure of claim 11, wherein the barrier layer is selected from the group consisting of a metal oxide coating layer, an aluminum oxide (AlOx) coating layer, a silicon oxide (SiOx) coating layer, a metallization layer, an aluminum metallization layer, an aluminum foil layer, a polyvinyl alcohol (PVOH) layer, an ethylene vinyl alcohol copolymer (EVOH) layer, and a polyamide layer.

13. The film structure of claim 1, further comprising a barrier layer disposed on outer layer.

14. The film structure of claim 13, wherein the barrier layer is selected from the group consisting of a metal oxide coating layer, an aluminum oxide (AlOx) coating layer, a silicon oxide (SiOx) coating layer, a metallization layer, an aluminum metallization layer, an aluminum foil layer, a polyvinyl alcohol (PVOH) layer, an ethylene vinyl alcohol copolymer (EVOH) layer, and a polyamide layer.

15. The film structure of claim 1, wherein the at least one polymer-based film layer independently comprises a polymer selected from the group consisting of polyethylene (PE), polypropylene (PP), polyolefin blends, polyolefin copolymers, low-density polyethylene (LDPE), very low-density polyethylene (VLDPE), linear low-density polyethylene (LLDPE), medium density polyethylene (MDPE), linear medium density polyethylene (LMDPE), high-density polyethylene (HDPE), metallocene polyethylene including metallocene linear low-density polyethylene (mLLDPE), polyolefin plastomer (POP), cyclic olefin copolymer (COC), cast polypropylene (CPP), ethylene-propylene copolymer (EPC), monoaxially- and biaxially-oriented polyolefins, biaxially oriented polypropylene (BOPP), and other polyolefin materials, post-consumer recycled (PCR) polyolefins, as well as blends, coextrusions, and laminations of any of the foregoing.

16. The film structure of claim 1, wherein the at least one polymer-based film layer independently comprises a polymer coextrusion comprising:
a first coextrusion layer comprising a polyolefin admixed with the multifunctional polar polymer compatibilizer;
a second coextrusion layer comprising a polyolefin admixed with the multifunctional polar polymer compatibilizer; and
a coextrusion barrier layer disposed intermediate the first and second coextrusion layers.

17. The film structure of claim 16, further comprising a first tie layer disposed intermediate the first coextrusion layer and the coextrusion barrier layer and a second tie layer disposed intermediate the second coextrusion layer and the coextrusion barrier layer.

18. The film structure of claim 16, wherein the coextrusion barrier layer comprises one or more polymers selected from the group consisting of polyvinyl alcohol (PVOH), ethylene vinyl alcohol copolymer (EVOH), and nylon.

19. The film structure of claim 1, wherein the at least one polymer-based film layer independently comprises a polymer coextrusion comprising:
a first coextrusion layer comprising a polyolefin admixed with the multifunctional polar polymer compatibilizer;
a second coextrusion layer comprising a polyolefin admixed with the multifunctional polar polymer compatibilizer, the second coextrusion layer adjacent the first coextrusion layer;
a third coextrusion layer comprising a polyolefin admixed with the multifunctional polar polymer compatibilizer;
a fourth coextrusion layer comprising a polyolefin admixed with the multifunctional polar polymer compatibilizer, the second coextrusion layer adjacent the third coextrusion layer; and
a coextrusion barrier layer disposed intermediate the second and third coextrusion layers.

20. The film structure of claim 19, further comprising a first tie layer disposed intermediate the second coextrusion layer and the coextrusion barrier layer and a second tie layer disposed intermediate the third coextrusion layer and the coextrusion barrier layer.

21. The film structure of claim 19, wherein the coextrusion barrier layer comprises one or more polymers selected from the group consisting of polyvinyl alcohol (PVOH), ethylene vinyl alcohol copolymer (EVOH), and nylon.

22. The film structure of claim 1, wherein the multifunctional polar polymer compatibilizer comprises a functional polymer with at least two different functional groups selected from the group consisting of a carboxylic acid, an ester, an anhydride, an aldehyde, a ketone, an isocyanate, an epoxide, an acrylate, an alkene, an alkyne, a nitroso, an imide, a carbonate, a nitrile, an acid halide, a phosphoric acid derivative, an alkyl halide, a sulfonyl halide, an aziridine, a halogen, a carbene, and a sulfonic acid group.

23. The film structure of claim 22, wherein the multifunctional polar polymer compatibilizer comprises a polyolefin functionalized with at least two different functional groups selected from the group consisting of a carboxylic acid, an ester, an anhydride, an aldehyde, a ketone, an isocyanate, an epoxide, an alkene, an alkyne, and a nitroso group.

24. The film structure of claim 1, wherein the multifunctional polar polymer compatibilizer is selected from the group consisting of:
a polyolefin-based polymer system which is functionalized with two or more different functional groups on the same polymer chain or molecule;
a blend of two or more polyolefin-based polymers, each of which is functionalized with a different functional group;
a copolymer comprising monomer units derived from at least two monomers having different functional groups; and
a combination thereof.

25. A packaging article formed of the film structure according to claim 1.
